(19) United States
(12) Patent Application Publication
(10) Pub. No.: US 2009/0298992 A1
(43) Pub. Date: Dec. 3, 2009

(54) THERMOPLASTIC COMPOSITIONS, METHOD OF MANUFACTURE, AND USES THEREOF

(76) Inventors: Mousumi DE SARKAR, Bangalore (IN); Rajashekhar Shiddappa TOTAD, Karnataka (IN)

Correspondence Address: CANTOR COLBURN LLP - SABIC (LEXAN/CYCOLOY), 20 Church Street, 22nd Floor, Hartford, CT, 06103, US

(21) Appl. No.: 12/130,237

(22) Filed: May 30, 2008

(51) Int. Cl. C08J 3/20; C08K 3/34

(52) U.S. Cl. 524/445; 524/538; 524/451; 524/449

(57) ABSTRACT

A composition is described, comprising: a polymer component comprising, based on the total weight of the polymer component, 25 to 93 weight percent of a polycarbonate, 1 to 25 weight percent of a poly(vinyl acetate), 5 to 35 weight percent of a poly(monovinyl aryl-co-(meth)acrylonitrile) flow modifier, and 1 to 20 to weight percent of a poly(monovinyl aryl-co-maleic) compatibilizer; and an optional filler component, in an amount of 0 to 150 parts by weight of the polymer component.

### BACKGROUND

This disclosure relates to thermoplastic compositions, in particular thermoplastic compositions containing a polycarbonate, an impact modifier, and a compatibilizer; methods for the manufacture of such compositions; and articles formed from the compositions.

Thermoplastic compositions containing a blend of a polycarbonate and a high rubber-modified graft copolymer (HRG), together with a mineral filler, are useful in the manufacture of articles and components for a wide range of applications, from automotive parts to electronic appliances. Such thermoplastic compositions have been described, for example, in U.S. Pat. No. 5,162,419, and U.S. Pat. No. 5,091,461.

However, some commercially available polycarbonate-HRG blends can yellow upon aging and suffer from loss of mechanical properties upon environmental exposure (“weathering”). Weatherability of polycarbonate-ABS compositions is improved with the addition of polyacrylates as impact modifiers, but polyacrylates are cost-prohibitive for many applications, offer limited low temperature impact performance, and have limited melt flow, thus limiting their applicability in the manufacture of molded articles. Additives such as benzotriazoles, benzotriazenes, and hindered amine light stabilizers (HALS) have been used to improve weatherability. However, these materials are cost prohibitive for many applications and their migration and leaching from an article are undesirable.

Thus there remains a need in the art for thermoplastic compositions having an improved balance of at least one of scratch resistance, impact strength, aging performance, melt flow, and chemical resistance. It would be advantageous if such improvement were obtained without significantly adversely affecting the desirable modulus and ductility properties associated with polycarbonates. There particularly remains a need in the art for thermoplastic compositions having improved weatherability, while at the same time maintaining or improving the balance between heat resistance, flow, and impact properties.

### BRIEF DESCRIPTION

The above-described and other drawbacks are alleviated by a composition comprising: a polymer component comprising, based on the total weight of the polymer component, 25 to 93 weight percent of a polycarbonate, 1 to 25 weight percent of a poly(vinyl acetate), 5 to 35 weight percent of a poly(monovinyl aryl-co-(meth)acrylonitrile) flow modifier, and 1 to 20 to weight percent of a poly(monovinyl aryl-co-maleic) compatibilizer; and an optional filler component, in an amount of 0 to 150 parts by weight of the polymer component.

A method of forming a composition comprises combining the foregoing components to form the composition.

Articles are also described, comprising the foregoing composition.

Also described are methods of forming the articles, comprising molding, casting, or shaping the foregoing composition.

These and other features, aspects, and advantages of the disclosed embodiments will become better understood with reference to the following drawings, detailed description, and appended claims.

### BRIEF DESCRIPTION OF THE DRAWINGS

FIG. 1 illustrates nano-scratch resistance testing results on articles molded from the thermoplastic compositions of Comparative Example 16 (C16) and Example 5 (E5), and shows photomicrographs of the scratched surface (100× magnification) of each article and the cross-profile topography of the scratches.

FIG. 2 is a photograph of bars molded from the thermoplastic compositions of C16 and E5 subjected to a heat aging at 130° C. for up to 500 hours.

FIG. 3 is a photograph of bars molded from the thermoplastic compositions of C16 and E5 subjected to heat aging at different temperatures for 500 hours.

FIG. 4 is a plot of percent retention in elongation at break of bars molded from the thermoplastic compositions of C16 (circles) and E5 (squares) subjected to heat aging at 130° C.

### DETAILED DESCRIPTION

It has been found by the inventors that thermoplastic compositions comprising polycarbonate, a specific type of impact modifier (a poly(vinyl acetate)), a specific type of flow modifier (a poly(monovinyl aryl-co-(meth)acrylonitrile)), and a specific type of compatibilizer (poly(monovinyl aryl-co-maleic anhydride)) have an improved balance of flow, mechanical, and weathering properties. In particular, thermoplastic compositions comprising polycarbonate, a poly(ethylene-co-vinyl acetate) (EVA) impact modifier, a poly(styrene-co-acrylonitrile) (SAN) flow modifier, and a poly(styrene-co-maleic anhydride) (SMA) compatibilizer provide at least one of improved scratch resistance, impact resistance, chemical resistance, aging performance, and/or flow properties. In one embodiment the improvement is obtained without significant loss of the desirable tensile and creep properties associated with polycarbonates. In a particularly advantageous embodiment, it has been discovered that the thermoplastic compositions provide all of the foregoing improved properties, together with good tensile properties. Such compositions are particularly advantageous because they offer improved weatherability compared to certain commercially available polycarbonate-ABS blends, without compromising other desirable properties.

As used herein, the term “polycarbonate” means compositions having repeating structural carbonate units of formula (1):

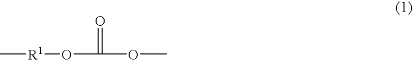

in which at least 60 percent of the total number of R¹ groups contain aromatic moieties and the balance thereof are aliphatic, alicyclic, or aromatic. In an embodiment, each R¹ is a C₆₋₃₀ aromatic group, that is, contains at least one aromatic moiety. R¹ can be derived from a dihydroxy compound of the formula HO—R¹—OH, in particular of formula (2):

HO-A¹-Y¹-A²-OH (2)

wherein each of A¹ and A² is a monocyclic divalent aromatic group and Y¹ is a single bond or a bridging group having one or more atoms that separate A^{l} from A². In an exemplary embodiment, one atom separates A¹ from A². Specifically, each R¹ can be derived from a dihydroxy aromatic compound of formula (3):

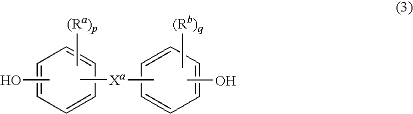

wherein R^{a} and R^{b} are each independently a halogen or C₁₋₁₂ alkyl group and can be the same or different; and p and q are each independently integers of 0 to 4. It will be understood that R^{a} is hydrogen when p is 0, and likewise R^{b} is hydrogen when q is 0. Also in formula (3), X^{a} represents a bridging group connecting the two hydroxy-substituted aromatic groups, where the bridging group and the hydroxy substituent of each C₆ arylene group are disposed ortho, meta, or para (specifically para) to each other on the C₆ arylene group. In an embodiment, the bridging group X^{a} is single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In one embodiment, p and q are each 1, and R^{a} and R^{b} are each a C₁₋₃ alkyl group, specifically methyl, disposed meta to the hydroxy group on each arylene group.

In an embodiment, X^{a} is a substituted or unsubstituted C₃₋₁₈ cycloalkylidene, a C₁₋₂₅ alkylidene of formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})— wherein R^{e} is a divalent C₁₋₁₂ hydrocarbon group. Exemplary groups of this type include methylene, cyclohexylmethylene, ethylidene, neopentylidene, and isopropylidene, as well as 2-[2.2.1]-bicycloheptylidene, cyclohexylidene, cyclopentylidene, cyclododecylidene, and adamantylidene. A specific example wherein X^{a} is a substituted cycloalkylidene is the cyclohexylidene-bridged, alkyl-substituted bisphenol of formula (4):

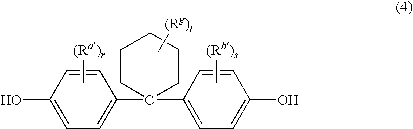

wherein R^{a′} and R^{b′} are each independently C₁₋₁₂ alkyl, R^{g} is C₁₋₁₂ alkyl or halogen, r and s are each independently 1 to 4, and t is 0 to 10. In a specific embodiment, at least one of each of R^{a′} and R^{b′} are disposed meta to the cyclohexylidene bridging group. The substituents R^{a′}, R^{b′}, and R^{g} can, when comprising an appropriate number of carbon atoms, be straight chain, cyclic, bicyclic, branched, saturated, or unsaturated. In an embodiment, R^{a′} and R^{b′} are each independently C₁₋₄ alkyl, R^{g} is C₁₋₄ alkyl, r and s are each 1, and t is 0 to 5. In another specific embodiment, R^{a′}, R^{b′} and R^{g} are each methyl, r and s are each 1, and t is 0 or 3. The cyclohexylidene-bridged bisphenol can be the reaction product of two moles of o-cresol with one mole of cyclohexanone. In another exemplary embodiment, the cyclohexylidene-bridged bisphenol is the reaction product of two moles of a cresol with one mole of a hydrogenated isophorone (e.g., 1,1,3-trimethyl-3-cyclohexane-5-one). Such cyclohexane-containing bisphenols, for example the reaction product of two moles of a phenol with one mole of a hydrogenated isophorone, are useful for making polycarbonate polymers with high glass transition temperatures and high heat distortion temperatures.

In another embodiment, X^{a} is a C₁₋₁₈ alkylene group, a C₃₋₁₈ cycloalkylene group, a fused C₆₋₁₈ cycloalkylene group, or a group of the formula —B¹—W—B²— wherein B¹ and B² are the same or different C₁₋₆ alkylene group and W is a C₃₋₁₂ cycloalkylidene group or a C₆₋₁₆ arylene group.

X^{a} can also be a substituted C₃₋₁₈ cycloalkylidene of formula (5):

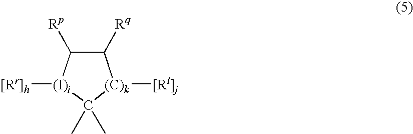

wherein R^{r}, R^{p}, R^{q}, and R^{t} are each independently hydrogen, halogen, oxygen, or C₁₋₁₂ organic groups; I is a direct bond, a carbon, or a divalent oxygen, sulfur, or —N(Z)- wherein Z is hydrogen, halogen, hydroxy, C₁₋₁₂ alkyl, C₁₋₁₂ alkoxy, or C₁₋₁₂ acyl; h is 0 to 2, j is 1 or 2, i is an integer of 0 or 1, and k is an integer of 0 to 3, with the proviso that at least two of R^{r}, R^{p}, R^{q}, and R^{t} taken together are a fused cycloaliphatic, aromatic, or heteroaromatic ring. It will be understood that where the fused ring is aromatic, the ring as shown in formula (5) will have an unsaturated carbon-carbon linkage where the ring is fused. When k is 1 and i is 0, the ring as shown in formula (5) contains 4 carbon atoms, when k is 2, the ring as shown in formula (5) contains 5 carbon atoms, and when k is 3, the ring contains 6 carbon atoms. In one embodiment, two adjacent groups (e.g., R^{q} and R^{t} taken together) form an aromatic group, and in another embodiment, R^{q} and R^{t} taken together form one aromatic group and R^{r} and R^{p} taken together form a second aromatic group. When R^{q} and R^{t} taken together form an aromatic group, R^{p} can be a double-bonded oxygen atom, i.e., a ketone.

Other useful aromatic dihydroxy compounds of the formula HO—R¹—OH include compounds of formula (6):

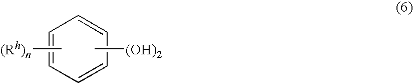

wherein each R^{h} is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0 to 4. The halogen is usually bromine.

Some illustrative examples of specific aromatic dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or combinations comprising at least one of the foregoing dihydroxy compounds.

Specific examples of bisphenol compounds of formula (3) include 1,1-bis(4-hydroxyphenyl)methane, 1,1-bis(4-hydroxyphenyl)ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). Combinations comprising at least one of the foregoing dihydroxy compounds can also be used. In one specific embodiment, the polycarbonate is a linear homopolymer derived from bisphenol A, in which each of A¹ and A² is p-phenylene and Y¹ is isopropylidene in formula (3).

The polycarbonates can have an intrinsic viscosity, as determined in chloroform at 25° C., of 0.3 to 1.5 deciliters per gram (dl/gm), specifically 0.45 to 1.0 dl/gm. The polycarbonates can have a weight average molecular weight of 10,000 to 200,000 Daltons, specifically 20,000 to 100,000 Daltons, as measured by gel permeation chromatography (GPC), using a crosslinked styrene-divinylbenzene column and calibrated to polycarbonate references. GPC samples are prepared at a concentration of 1 mg per ml, and are eluted at a flow rate of 1.5 ml per minute.

In one embodiment, the polycarbonate has flow properties useful for the manufacture of thin articles. Melt volume flow rate (often abbreviated MVR) measures the rate of extrusion of a thermoplastic through an orifice at a prescribed temperature and load. Polycarbonates useful for the formation of thin articles can have an MVR, measured at 260° C./5 kg, of 1 to 30 cubic centimeters per 10 minutes (cc/10 min), specifically, 2 to 20 cc/10 min. Combinations of polycarbonates of different flow properties can be used to achieve the overall desired flow property.

“Polycarbonates” as used herein includes homopolycarbonates (wherein each R¹ in the polymer is the same), copolymers comprising different R¹ moieties in the carbonate units (referred to herein as “copolycarbonates”), copolymers comprising carbonate units and other types of polymer units, such as ester units, and combinations comprising at least one of a homopolycarbonate and/or a copolycarbonate. As used herein, a “combination” is inclusive of blends, mixtures, alloys, reaction products, and the like.

A specific type of copolymer is a polyester carbonate, also known as a polyester-polycarbonate. Such copolymers further contain, in addition to recurring carbonate chain units of formula (1), repeating units of formula (7):

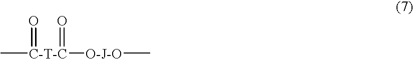

wherein J is a divalent group derived from a dihydroxy compound, and can be, for example, a C₂₋₁₀ alkylene group, a C₆₋₂₀ alicyclic group, a C₆₋₂₀ aromatic group or a polyoxyalkylene group in which the alkylene groups contain 2 to 6 carbon atoms, specifically 2, 3, or 4 carbon atoms; and T divalent group derived from a dicarboxylic acid, and can be, for example, a C₂₋₁₀ alkylene group, a C₆₋₂₀ alicyclic group, a C₆₋₂₀ alkyl aromatic group, or a C₆₋₂₀ aromatic group. Copolyesters containing a combination of different T and/or J groups can be used. The polyesters can be branched or linear.

In one embodiment, J is a C₂₋₃₀ alkylene group having a straight chain, branched chain, or cyclic (including polycyclic) structure. In another embodiment, J is derived from an aromatic dihydroxy compound of formula (3) above. In another embodiment, J is derived from an aromatic dihydroxy compound of formula (4) above. In another embodiment, J is derived from an aromatic dihydroxy compound of formula (6) above.

Examples of aromatic dicarboxylic acids that can be used to prepare the polyester units include isophthalic or terephthalic acid, 1,2-di(p-carboxyphenyl)ethane, 4,4′-dicarboxydiphenyl ether, 4,4′-bisbenzoic acid, and combinations comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or combinations thereof. A specific dicarboxylic acid comprises a combination of isophthalic acid and terephthalic acid wherein the weight ratio of isophthalic acid to terephthalic acid is 91:9 to 2:98. In another specific embodiment, J is a C₂₋₆ alkylene group and T is p-phenylene, m-phenylene, naphthalene, a divalent cycloaliphatic group, or a combination thereof. This class of polyester includes the poly(alkylene terephthalates).

The molar ratio of ester units to carbonate units in the copolymers can vary broadly, for example 1:99 to 99:1, specifically 10:90 to 90:10, more specifically 25:75 to 75:25, depending on the desired properties of the final composition.

In a specific embodiment, the polyester unit of a polyester-polycarbonate can be derived from the reaction of a combination of isophthalic and terephthalic diacids (or derivatives thereof) with resorcinol. In another specific embodiment, the polyester unit of a polyester-polycarbonate is derived from the reaction of a combination of isophthalic acid and terephthalic acid with bisphenol A. In a specific embodiment, the polycarbonate units are derived from bisphenol A. In another specific embodiment, the polycarbonate units are derived from resorcinol and bisphenol A in a molar ratio of resorcinol carbonate units to bisphenol A carbonate units of 1:99 to 99:1.

Polycarbonates can be manufactured by processes such as interfacial polymerization and melt polymerization. Although the reaction conditions for interfacial polymerization can vary, an exemplary process generally involves dissolving or dispersing a dihydric phenol reactant in aqueous caustic soda or potash, adding the resulting mixture to a water-immiscible solvent medium, and contacting the reactants with a carbonate precursor in the presence of a catalyst such as triethylamine and/or a phase transfer catalyst, under controlled pH conditions, e.g., 8 to 12. The most commonly used water immiscible solvents include methylene chloride, 1,2-dichloroethane, chlorobenzene, toluene, and the like.

Exemplary carbonate precursors include, for example, a carbonyl halide such as carbonyl bromide or carbonyl chloride, or a haloformate such as a bishaloformates of a dihydric phenol (e.g., the bischloroformate of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors can also be used. In an exemplary embodiment, an interfacial polymerization reaction to form carbonate linkages uses phosgene as a carbonate precursor, and is referred to as a phosgenation reaction.

Among the phase transfer catalysts that can be used are catalysts of the formula (R³)₄Q⁺X, wherein each R³ is independently the same or different, and is a C₁₋₁₀ alkyl group; Q is a nitrogen or phosphorus atom; and X is a halogen atom or a C₁₋₈ alkoxy group or C₆₋₁₈ aryloxy group. Exemplary phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst can be 0.1 to 10 weight percent (wt. %) based on the weight of bisphenol in the phosgenation mixture. In another embodiment an effective amount of phase transfer catalyst can be 0.5 to 2 wt. % based on the weight of bisphenol in the phosgenation mixture.

All types of polycarbonate end groups are contemplated, as being useful in the thermoplastic composition, provided that such end groups do not significantly adversely affect desired properties of the compositions.

Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents can be added at a level of 0.05 to 2.0 wt. %. Mixtures comprising linear polycarbonates and branched polycarbonates can be used.

A chain stopper (also referred to as a capping agent) can be included during polymerization. The chain stopper limits molecular weight growth rate, and so controls molecular weight in the polycarbonate. Exemplary chain stoppers include certain mono-phenolic compounds, mono-carboxylic acid chlorides, and/or mono-chloroformates. Mono-phenolic chain stoppers are exemplified by monocyclic phenols such as phenol and C₁₋₂₂ alkyl-substituted phenols such as p-cumyl-phenol, resorcinol monobenzoate, and p- and tertiary-butyl phenol; and monoethers of diphenols, such as p-methoxyphenol. Alkyl-substituted phenols with branched chain alkyl substituents having 8 to 9 carbon atom can be specifically mentioned. Certain mono-phenolic UV absorbers can also be used as a capping agent, for example 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, and the like.

Mono-carboxylic acid chlorides can also be used as chain stoppers. These include monocyclic, mono-carboxylic acid chlorides such as benzoyl chloride, C₁₋₂₂ alkyl-substituted benzoyl chloride, toluoyl chloride, halogen-substituted benzoyl chloride, bromobenzoyl chloride, cinnamoyl chloride, 4-nadimidobenzoyl chloride, and combinations thereof; polycyclic, mono-carboxylic acid chlorides such as trimellitic anhydride chloride, and naphthoyl chloride; and combinations of monocyclic and polycyclic mono-carboxylic acid chlorides. Chlorides of aliphatic monocarboxylic acids with less than or equal to 22 carbon atoms are useful. Functionalized chlorides of aliphatic monocarboxylic acids, such as acryloyl chloride and methacryoyl chloride, are also useful. Also useful are mono-chloroformates including monocyclic, mono-chloroformates, such as phenyl chloroformate, alkyl-substituted phenyl chloroformate, p-cumyl phenyl chloroformate, toluene chloroformate, and combinations thereof.

Alternatively, melt processes can be used to make the polycarbonates. Generally, in the melt polymerization process, polycarbonates can be prepared by co-reacting, in a molten state, the dihydroxy reactant(s) and a diaryl carbonate ester, such as diphenyl carbonate, in the presence of a transesterification catalyst in a Banbury® mixer, twin screw extruder, or the like to form a uniform dispersion. Volatile monohydric phenol is removed from the molten reactants by distillation and the polymer is isolated as a molten residue. A specifically useful melt process for making polycarbonates uses a diaryl carbonate ester having electron-withdrawing substituents on the aryls. Examples of specifically useful diaryl carbonate esters with electron withdrawing substituents include bis(4-nitrophenyl)carbonate, bis(2-chlorophenyl)carbonate, bis(4-chlorophenyl)carbonate, bis(methyl salicyl)carbonate, bis(4-methylcarboxylphenyl) carbonate, bis(2-acetylphenyl) carboxylate, bis(4-acetylphenyl) carboxylate, or a combination comprising at least one of the foregoing esters. In addition, useful transesterification catalysts can include phase transfer catalysts of formula (R³)₄Q⁺X, wherein each R³, Q, and X are as defined above. Exemplary transesterification catalysts include tetrabutylammonium hydroxide, methyltributylammonium hydroxide, tetrabutylammonium acetate, tetrabutylphosphonium hydroxide, tetrabutylphosphonium acetate, tetrabutylphosphonium phenolate, or a combination comprising at least one of the foregoing.

The polyester-polycarbonates can also be prepared by interfacial polymerization. Rather than utilizing the dicarboxylic acid or diol per se, the reactive derivatives of the acid or diol, such as the corresponding acid halides, in particular the acid dichlorides and the acid dibromides can be used. Thus, for example instead of using isophthalic acid, terephthalic acid, or a combination comprising at least one of the foregoing acids, isophthaloyl dichloride, terephthaloyl dichloride, or a combination comprising at least one of the foregoing dichlorides can be used.

Suitable polycarbonates also include polyorganosiloxane-polycarbonate copolymers, also referred to as polysiloxane-polycarbonates. The polydiorganosiloxane blocks of the copolymer comprise repeating diorganosiloxane units of formula (8):

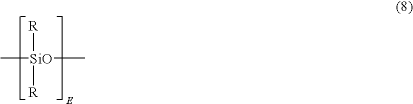

wherein each R is independently the same or different C₁₋₁₃ monovalent organic group. For example, R can be a C₁₋₁₃ alkyl, C₁₋₁₃ alkoxy, C₂₋₁₃ alkenyl group, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkyl, C₇₋₁₃ aralkoxy, C₇₋₁₃ alkylaryl, or C₇₋₁₃ alkylaryloxy. The foregoing groups can be fully or partially halogenated with fluorine, chlorine, bromine, or iodine, or a combination thereof. In an embodiment, where a transparent polyorganosiloxane-polycarbonate is desired, R is unsubstituted by halogen. Combinations of the foregoing R groups can be used in the same copolymer.

The value of E in formula (8) can vary widely depending on the type and relative amount of each component in the thermoplastic composition, the desired properties of the composition, and like considerations. Generally, E has an average value of 10 to 5,000, specifically 15 to 1,000, more specifically 20 to 500. In one embodiment, E has an average value of 10 to 75, and in still another embodiment, E has an average value of 40 to 60. Where E is of a lower value, e.g., less than 40, it can be desirable to use a relatively larger amount of the polyorganosiloxane-polycarbonate copolymer. Conversely, where E is of a higher value, e.g., greater than 40, a relatively lower amount of the polyorganosiloxane-polycarbonate copolymer can be used. A combination of a first and a second (or more) polyorganosiloxane-polycarbonate copolymer can be used, wherein the average value of E of the first copolymer is less than the average value of E of the second copolymer.

In one embodiment, the polyorganosiloxane blocks are provided by repeating structural units of formula (9):

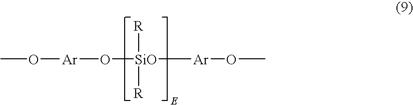

wherein E is as defined above; each R is independently the same or different, and is as defined above; and Ar can be the same or different, and is a substituted or unsubstituted C₆₋₃₀ arylene group, wherein the bonds are directly connected to an aromatic moiety. The Ar groups in formula (9) can be derived from a C₆₋₃₀ dihydroxyarylene compound, for example a dihydroxyarylene compound of formula (3) or (6) above. Exemplary dihydroxyarylene compounds are 1,1-bis(4-hydroxyphenyl)methane, 1,1-bis(4-hydroxyphenyl)ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl)cyclohexane, bis(4-hydroxyphenyl sulfide), and 1,1-bis(4-hydroxy-t-butylphenyl) propane. Combinations comprising at least one of the foregoing dihydroxy compounds can also be used.

In another embodiment, polyorganosiloxane blocks comprise units of formula (10):

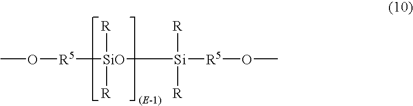

wherein R and E are as described above, and each R⁵ is independently a divalent C₁₋₃₀ organic group, and wherein the polymerized polyorganosiloxane unit is the reaction residue of its corresponding dihydroxy compound. In a specific embodiment, the polyorganosiloxane blocks are provided by repeating structural units of formula (11):

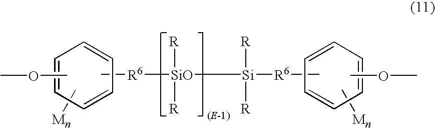

wherein R and E are as defined above. R⁶ in formula (11) is a divalent C₂₋₈ aliphatic group. Each M in formula (11) can be the same or different, and can be a halogen, cyano, nitro, C₁₋₈ alkylthio, C₁₋₈ alkyl, C₁₋₈ alkoxy, C₂₋₈ alkenyl, C₂₋₈ alkenyloxy group, C₃₋₈ cycloalkyl, C₃₋₈ cycloalkoxy, C₆₋₁₀ aryl, C₆₋₁₀ aryloxy, C₇₋₁₂ aralkyl, C₇₋₁₂ aralkoxy, C₇₋₁₂ alkylaryl, or C₇₋₁₂ alkylaryloxy, wherein each n is independently 0, 1, 2, 3, or 4.

In one embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R⁶ is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a combination of methyl and trifluoropropyl, or a combination of methyl and phenyl. In still another embodiment, M is methoxy, n is one, R⁶ is a divalent C₁₋₃ aliphatic group, and R is methyl.

Units of formulas (9), (10), and (11) can be derived from the corresponding dihydroxy polyorganosiloxanes as is known in the art.

The polyorganosiloxane-polycarbonate can comprise 50 to 99 wt. % of carbonate units and 1 to 50 wt. % siloxane units. Within this range, the polyorganosiloxane-polycarbonate copolymer can comprise 70 to 98 wt. %, more specifically 75 to 97 wt. % of carbonate units and 2 to 30 wt. %, more specifically 3 to 25 wt. % siloxane units.

Polyorganosiloxane-polycarbonates can have a weight average molecular weight of 2,000 to 100,000 Daltons, specifically 5,000 to 50,000 Daltons as measured by gel permeation chromatography using a crosslinked styrene-divinyl benzene column, at a sample concentration of 1 milligram per milliliter, and as calibrated with polycarbonate standards. The polyorganosiloxane-polycarbonate can have a melt volume flow rate, measured at 300° C./1.2 kg, of 1 to 50 cubic centimeters per 10 minutes (cc/10 min), specifically, 2 to 30 cc/10 min. Mixtures of polyorganosiloxane-polycarbonates of different flow properties can be used to achieve the overall desired flow property. Polysiloxane-polycarbonates are generally used in combination with other polycarbonates, in particular a bisphenol A homopolycarbonate. The polysiloxane-polycarbonate and other polycarbonate can be used in a weight ratio of polysiloxane-polycarbonate: other polycarbonate of 1:99 to 99:1, specifically 10:90 to 90:10, and more specifically 30:70 to 70:30, and still more specifically 1:99 to 20:80, to depending on the function of the composition and the properties desired.

In addition to the polycarbonates described above, combinations of the polycarbonate with other thermoplastic polymers, for example combinations of homopolycarbonates and/or copolycarbonates with polyesters, polyamides, polyarylene ethers, and the like can be used. Useful polyesters can include, for example, polyesters having repeating units of formula (7), which include poly(alkylene dicarboxylates), liquid crystalline polyesters, and polyester copolymers. The other polymers, in particular polyesters, are generally completely miscible with the polycarbonates when blended. The polycarbonate and other polymer(s) can be used in a weight ratio of 1:99 to 99:1, specifically 10:90 to 90:10, and more specifically 30:70 to 70:30, depending on the application and desired properties of the compositions.

The thermoplastic compositions further comprise a poly(vinyl acetate) impact modifier, more specifically a poly(ethylene-co-vinyl acetate) impact modifier. Use of this type of impact modifier improves the flow, yellowness, and aging performance of the thermoplastic compositions compared to HRG. The poly(vinyl acetate) is derived from ethylenically unsaturated ester of formula (12):

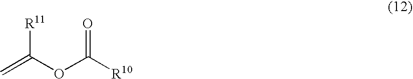

wherein R¹⁰ is a C₁₋₁₂ alkyl, C₃₋₁₂ cycloalkyl, C₆₋₁₂ aryl, C₇₋₁₂ aralkyl, or C₇₋₁₂ alkylaryl, and R¹¹ is a hydrogen, C₁₋₁₂ alkyl, C₃₋₁₂ cycloalkyl, C₆₋₁₂ aryl, C₇₋₁₂ aralkyl, or C₇₋₁₂ alkylaryl. In an embodiment, R¹⁰ is a C₁₋₆ alkyl, C₆₋₁₂ aryl, C₇₋₁₂ aralkyl, or C₇₋₁₂ alkylaryl, and R¹¹ is a hydrogen, C₁₋₆ alkyl, C₆₋₁₂ aryl, C₇₋₁₂ aralkyl, or C₇₋₁₂ alkylaryl. More specifically, R¹⁰ is a C₁₋₃ alkyl, C₆ aryl, C₇ aralkyl, or C₇ alkylaryl, and R¹¹ is a hydrogen, C₁₋₃ alkyl, C₆ aryl, C₇ aralkyl, or C₇ alkylaryl. An exemplary ethylenically unsaturated ester is vinyl acetate, wherein R¹⁰ is methyl and R¹¹ is hydrogen.

The poly(vinyl acetate) can be a homopolymer or a random, block, or graft copolymer derived from the reaction of an ethylenically unsaturated ester (12) and a C₂₋₆ aliphatic terminal monoolefin, including ethene (ethylene), 1,2-propylene, 1,2-butene, 1,2-pentene, and 1,2-hexene. The amount of olefin present in the poly(vinyl acetate) copolymer can be 2 to 80 mole percent, specifically 4 to 70 mole percent, and more specifically 6 to 60 mole percent.

Specifically, the olefin can be ethylene, thus in an embodiment the impact modifier component comprises poly(ethylene-co-vinyl acetate). A specific poly(ethylene-co-vinyl acetate) has a weight average molecular weight from 5000 to 300,000 Daltons, specifically 100,000 to 250,000 Daltons. The amount of ethylene present in the poly(ethylene vinyl acetate) copolymer can be 20 to 80 mole percent, specifically 40 to 70 mole percent, and more specifically 45 to 60 mole percent.

Other impact modifiers can optionally be present, in amounts of 0 to 10 wt. % of the total weight of the impact modifier component, provided that such impact modifiers do not significantly adversely affect the desired properties of the polycarbonate composition. Exemplary other impact modifiers include natural rubber, fluoroelastomers, ethylene-propylene rubber (EPR), ethylene-butene rubber, ethylene-propylene-diene monomer rubber (EPDM), acrylate rubbers, hydrogenated nitrile rubber (HNBR) silicone elastomers, and elastomer-modified graft copolymers such as styrene-butadiene-styrene (SBS), styrene-butadiene rubber (SBR), styrene-ethylene-butadiene-styrene (SEBS), acrylonitrile-butadiene-styrene (ABS), acrylonitrile-ethylene-propylene-diene-styrene (AES), styrene-isoprene-styrene (SIS), methyl methacrylate-butadiene-styrene (MBS), HRG rubber, and the like. In one embodiment, no other impact modifier is present in addition to the poly(vinyl acetate) or poly(vinyl acetate) copolymer.

The thermoplastic compositions further comprise a poly(monovinyl aryl-co-(meth)acrylonitrile) flow modifier that improves the flow characteristics of the thermoplastic compositions. The poly(monovinyl aryl-co-(meth)acrylonitrile) copolymers can be random, block, or graft copolymers, and are derived by the polymerization of a monovinyl aryl monomer and a (meth)acrylonitrile monomer. The aromatic monovinyl compound is of the formula (13):

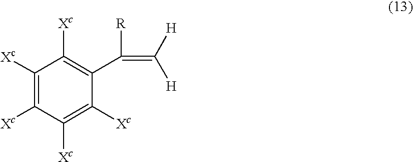

wherein each X^{c} is independently hydrogen, C₁₋₁₂ alkyl, C₃₋₁₂ cycloalkyl, C₆₋₁₂ aryl, C₇₋₁₂ aralkyl, C₇₋₁₂ alkylaryl, C₁₋₁₂ alkoxy, C₃₋₁₂ cycloalkoxy, C₆₋₁₂ aryloxy, chloro, bromo, or hydroxy, and R is hydrogen, C₁₋₅ alkyl, bromo, or chloro. Exemplary monovinyl aryl monomers that can be used include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, or the like, or combinations comprising at least one of the foregoing monomers. Specifically, the monovinyl aryl monomer is styrene and/or α-methylstyrene, and even more specifically the monovinyl aryl monomer is styrene. When styrene is used, small amounts (0 to 10 wt. %) of other styrene-based monomers can be present, such as alpha-methylstyrene, o-, m-, or p-methylstyrene, vinyl xylene, monochlorostyrene, dichlorostyrene, monobromostyrene, dibromostyrene, fluorostyrene, or p-tert-butylstyrene.

The monovinyl aryl monomer is polymerized with a (meth)acrylonitrile. As used herein, (meth)acrylonitrile means acrylonitrile, methacrylonitrile, or a combination thereof.

The ratio of monovinyl aryl monomer (e.g., styrene) to (meth)acrylonitrile is selected according to the intended application of the polycarbonate composition. In general, the copolymer contains 50 to 95 wt. %, specifically 60 to 85 wt. % of units derived from the monovinyl aryl monomer and 5 to 50 wt. %, specifically 15 to 40 wt. % of units derived from (meth)acrylonitrile.

The weight average molecular weight (Mw) of the poly(monovinyl aryl-co-(meth)acrylonitrile) can be 30,000 to 200,000 Daltons, optionally 40,000 to 110,000 Daltons, as measured by GPC using polystyrene molecular weight standards.

Methods for manufacture of the poly(monovinyl aryl-co-(meth)acrylonitrile) include bulk polymerization, solution polymerization, suspension polymerization, bulk suspension polymerization and emulsion polymerization. Moreover, individually copolymerized SAN copolymers of differing properties, e.g., composition, or molecular weight can be blended. The alkali metal content of the poly(monovinyl aryl-co-(meth)acrylonitrile) can be 1 ppm or less, optionally 0.5 ppm or less, for example, 0.1 ppm or less, by weight of the aromatic vinyl copolymer. Moreover, among alkali metals, the content of sodium and potassium in component (b) can be 1 ppm or less, and optionally 0.5 ppm or less, for example, 0.1 ppm or less.

In one embodiment, the flow modifier is poly(styrene-co-acrylonitrile) (SAN). A specific SAN suitable for use in the compositions has a weight average molecular weight from 40,000 to 200,000 Daltons, specifically 50,000 to 150,000 Daltons (measured via GPC using polystyrene standard molecular standards) and comprises various proportions of styrene to acrylonitrile, specifically 65 to 75 wt. % of units derived from styrene and 25 to 35 wt. % of units derived from acrylonitrile. Such SANs are commercially available from SABIC Innovative Plastics.

It has been found that a compatibilizer provides further improvement in the properties of the thermoplastic compositions. In thermoplastic compositions containing PVA impact modifiers, use of a poly(monovinyl aryl-co-maleic anhydride) compatibilizer provides thermoplastic compositions having decreased delamination compared to compositions using other types of compatibilizer such as poly(methyl methacrylate). Decreased delamination is especially important when talc is used as a filler, as talc tends to promote delamination.

The poly(monovinyl aryl-co-maleic anhydride) compatibilizer comprises units derived from the polymerization of a monovinyl aryl monomer of formula (13) as described above with a maleic anhydride of formula (14):

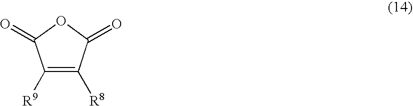

wherein R⁸ and R⁹ are each independently hydrogen, C₁₋₁₂ alkyl, C₃₋₁₂ cycloalkyl, C₆₋₁₂ aryl, C₇₋₁₂ aralkyl, C₇₋₁₂ alkylaryl, or a halogen. In one embodiment, R⁸ and R⁹ are the same, and are each hydrogen, C₁₋₃ alkyl, C₆ aryl, C₇₋₁₀ aralkyl, or C₇₋₁₀ alkylaryl, or a halogen. Specifically, the maleic anhydride of formula (14) is maleic anhydride, wherein R⁸ and R⁹ are each hydrogen.

The relative amount of the units derived from the monovinyl aryl monomer (13) and the units derived from the maleic anhydride (14) in the compatibilizer will vary, depending on the type and amount of polycarbonate and impact modifying components used. In general, the compatibilizer comprises from 2 to 75 mole percent of maleic derivative units, specifically 4 to 70 mole percent, more specifically 6 to 60 mole percent maleic derivative unties, with the balance being monovinyl aryl monomer units.

The relative amounts of each of the constituents of the polymer component of the thermoplastic composition (polycarbonate, impact modifier, flow modifier, and compatibilizer) will vary depending on the intended application and desired properties of the compositions. Advantageous properties are obtained from compositions that comprise 25 to 93 wt. % of the polycarbonate, 1 to 25 wt. % of the poly(vinyl acetate), specifically poly(ethylene vinyl acetate), 5 to 35 wt. % of the flow modifier, specifically SAN, and 1 to 20 wt. % of the compatibilizer, each based on the total weight of the polymer component (which excludes any filler).

In another embodiment, the thermoplastic composition comprises 43 to 83 wt. % of the polycarbonate, 5 to 20 wt. % of the poly(vinyl acetate), specifically poly(ethylene vinyl acetate), 10 to 25 wt. % of the flow modifier, specifically SAN, and 2 to 12 wt. % of the compatibilizer, each based on the total weight of the polymer component (which excludes any filler).

In another embodiment, the thermoplastic composition comprises 55 to 74 wt. % of the polycarbonate, 8 to 15 wt. % of the poly(vinyl acetate), specifically poly(ethylene vinyl acetate), 15 to 20 wt. % of the flow modifier, specifically SAN, and 3 to 10 wt. % of the compatibilizer, each based on the total weight of the polymer component (which excludes any filler).

In addition to the above components, the thermoplastic composition can include various additives ordinarily incorporated into resin compositions of this type, with the proviso that the additives are selected so as to not significantly adversely affect the desired properties of the thermoplastic composition, for example, impact strength. Combinations of additives can be used. Such additives can be mixed at a suitable time during the mixing of the components for forming the composition. Exemplary additives include fillers, reinforcing agents, antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, flame retardants, and anti-drip agents. A combination of additives can be used, for example a combination of a heat stabilizer, a mold release agent, and an ultraviolet light stabilizer. In general, the additives are used in the amounts generally known to be effective. The total amount of additives (other than any impact modifier, filler, or reinforcing agents) is generally 0.01 to 5 wt. %, based on the total weight of the polymer component.

Possible fillers or reinforcing agents include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (atmospheres), or the like; kaolin, including hard kaolin, soft kaolin, calcined kaolin, kaolin comprising various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel, or the like; flaked fillers such as glass flakes, flaked silicon carbide, aluminum diboride, aluminum flakes, steel flakes, or the like; fibrous fillers, for example short inorganic fibers such as those derived from blends comprising at least one of aluminum silicates, aluminum oxides, magnesium oxides, and calcium sulfate hemihydrate, or the like; natural fillers and reinforcements, such as wood flour obtained by pulverizing wood, fibrous products such as cellulose, cotton, sisal, jute, starch, cork flour, lignin, ground nut shells, corn, rice grain husks, or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol), or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

The fillers and reinforcing agents can be surface treated with coupling agents to improve adhesion and dispersion with the polymeric matrix resin. In addition, the reinforcing fillers can be provided in the form of monofilament or multifilament fibers and can be used individually or in combination with other types of fiber, through, for example, co-weaving or core/sheath, side-by-side, orange-type or matrix and fibril constructions, or by other methods known to one skilled in the art of fiber manufacture. Exemplary co-woven structures include glass fiber-carbon fiber, carbon fiber-aromatic polyimide (aramid) fiber, and aromatic polyimide fiberglass fiber, or the like. Fibrous fillers can be supplied in the form of, for example, rovings, woven fibrous reinforcements, such as 0-90 degree fabrics or the like; non-woven fibrous reinforcements such as continuous strand mat, chopped strand mat, tissues, papers and felts, or the like; or three-dimensional reinforcements such as braids. Fillers are generally used in amounts of 1 to 150 parts by weight, based on 100 parts by weight of total weight of the polymer component of the thermoplastic composition.

Exemplary antioxidant additives include organophosphites such as tris(nonyl phenyl)phosphite, tris(2,4-di-t-butylphenyl)phosphite, bis(2,4-di-t-butylphenyl)pentaerythritol diphosphite, and distearyl pentaerythritol diphosphite; alkylated monophenols or polyphenols; alkylated reaction products of polyphenols with dienes, such as tetrakis[methylene(3,5-di-tert-butyl-4-hydroxyhydrocinnamate)] methane; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, and pentaerythrityl-tetrakis [3-(3,5-di-tert-butyl-4-hydroxyphenyl)propionate; amides of beta-(3,5-di-tert-butyl-4-hydroxyphenyl)-propionic acid; or combinations comprising at least one of the foregoing antioxidants. Antioxidants are used in amounts of 0.01 to 0.1 parts by weight, based on 100 parts by weight of the total polymer component of the thermoplastic composition, which excludes any filler.

Light stabilizers and/or ultraviolet light (UV) absorbing additives can also be used. Exemplary additives of this type include hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB® 5411); 2-hydroxy-4-n-octyloxybenzophenone (CYASORB® 531); 2-[4,6-bis(2,4-dimethylphenyl)-1,3,5-triazin-2-yl]-5-(octyloxy)-phenol (CYASORB® 1164); 2,2′-(1,4-phenylene)bis(4H-3,1-benzoxazin-4-one) (CYASORB® UV-3638); 1,3-bis[(2-cyano-3,3-diphenylacryloyl)oxy]-2,2-bis[[(2-cyano-3,3-diphenylacryloyl)oxy]methyl]propane (UVINUL® 3030); 2,2′-(1,4-phenylene) bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than or equal to 100 nanometers; and combinations comprising at least one of the foregoing. Light stabilizers and/or UV absorbers are used in amounts of 0.01 to 5 parts by weight, based on 100 parts by weight of the total polymer component of the thermoplastic composition, which excludes any filler.

Plasticizers, lubricants, and/or mold release agents can also be used. There is considerable overlap among these types of materials, which include phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone, and the bis(diphenyl) phosphate of bisphenol A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate, and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a solvent; and waxes such as beeswax, montan wax, and paraffin wax. Such materials are used in amounts of 0.1 to 1 parts by weight, parts by weight of the total polymer component of the thermoplastic composition, which excludes any filler.

In other embodiments, the above-described thermoplastic compositions consist essentially of the named components in the specified amounts. In these embodiments, no other component is present that would significantly adversely affect the desired properties of the thermoplastic compositions, in particular impact strength, flow, heat aging, and/or delamination. Alternatively, the foregoing thermoplastic compositions consist of only the named components in the specified amounts, optionally together with one or more additives selected from the group consisting of antioxidants, heat stabilizers, light stabilizers, ultraviolet light stabilizers, plasticizers, lubricants, mold release agents, antistatic agents, colorants, radiation stabilizers, and flame retardants. In still another embodiment, the foregoing thermoplastic compositions consist of only the named components in the specified amounts, optionally together with one or more additives selected from the group consisting of antioxidants, heat stabilizers, light stabilizers, ultraviolet light stabilizers, plasticizers, lubricants, mold release agents, antistatic agents, colorants, and radiation stabilizers. Fillers, flame retardants, and other types of polymers are excluded from this last embodiment.

The thermoplastic compositions can be manufactured by various methods. For example, powdered polycarbonate, impact modifiers, compatibilizer, and/or other optional components are first blended, optionally with fillers in a HENSCHEL-Mixer® high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding directly into the extruder at the throat and/or downstream through a sidestuffer. Additives can also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate can be one-fourth inch long or less as desired. Such pellets can be used for subsequent molding, shaping, or forming.

The thermoplastic compositions described herein have an excellent balance of properties, in particular, improved stability, together with advantageous modulus, ductility, and flow properties.

Tensile properties such as tensile strength and tensile elongation to break can be determined using 4 mm thick molded tensile bars tested per ISO 527 at 5 mm/min. Tensile modulus is always measured at the start of the test with an initial rate of 1 mm/min. after which the test is continued at either 5 mm/min. to measure the other tensile properties.

Articles molded from the thermoplastic compositions can have a tensile strength of 45 to 60 megaPascals (MPa), specifically 50 to 60 MPa. Articles molded from the thermoplastic compositions can have a tensile modulus (E), specifically a Young's modulus, of 1 to 6 Gigapascals (Gpa), specifically 2 to 4 Gpa, more specifically 2 to 2.5 GPa. Articles molded from the thermoplastic compositions can further have a yield stress of 40 to 90 MPa, specifically 45 to 60 MPa. Articles molded from the thermoplastic compositions can further have a yield strain of 1 to 10%, specifically 2 to 8%. Articles molded from the thermoplastic compositions can further have a stress at break of 20 to 70 MPa, specifically 30 to 50 MPa. Articles molded from the thermoplastic compositions can further have a strain at break of 50 to 95%, specifically 70 to 90%. The elongation at break can be greater than 50 percent, specifically greater than 70 percent, more specifically greater than 80 percent. All of the foregoing properties are determined in accordance with ISO 527-5: 1997.

Multi-axial impact (MAI) performance data can be measured according to ISO 6603-2: 2000 at −30, −20, −10, 0, and 23° C. The test provides information on how a material behaves under multi-axial deformation conditions. The deformation is applied using a punch at a known velocity ranging from 2 to 5 m/sec. Results are expressed in Joules as total impact energy. The fracture mechanism of the sample is also reported as a percent of ductility. MAI percent ductility (at a given temperature, such as −30 or 23° C.) is reported as the percentage of five samples which, upon failure in the impact test, exhibited a ductile failure rather than rigid failure, the latter being characterized by cracking and the formation of shards. Articles molded from the thermoplastic compositions can have an MAI of 60 to 140 Joules, specifically 70 to 130 Joules, and more specifically 75 to 125 Joules at a temperature of −30° C.

Notched Izod impact strength can be used to compare the impact resistances of plastic materials. Izod impact was determined using a 3.2 mm thick, molded Izod notched impact (INI) bar, in accordance with ISO 180/1A. The ISO designation reflects type of specimen and type of notch: ISO 180/1A means specimen type 1 and notch type A. ISO 180/1U means the same type 1 specimen, but clamped in a reversed way (indicating unnotched). The ISO results are defined as the impact energy in joules used to break the test specimen, divided by the specimen area at the notch. Results are reported in kJ/m².

The thermoplastic compositions can have a notched Izod impact (NII) of 40 to 70 kilojoules per square meter (kJ/m²), specifically 45 to 60 kJ/m² measured at 23° C. using ⅛-inch (3.2 mm) thick bars in accordance with ISO 180: 2000. The thermoplastic compositions can have a notched Izod impact (NII) of 10 to 15 kJ/m², measured at −30° C. using ⅛-inch (3.2 mm) thick bars in accordance with ISO 180: 2000.

Melt Volume Rate (MVR) can be determined at 260° C. or 300° C., as indicated, using a 5 kilogram weight, over 10 minutes, in accordance with ISO 1133. The thermoplastic compositions can have a melt volume flow ratio (MVR) of 5 to 50, specifically 10 to 40 centimeters per 10 minutes (cm^{3/10} min), when measured at 260° C. under a load of 5.0 Kg in accordance with ISO 1133.

The thermoplastic compositions can have a melt viscosity at 300° C./5000 sec⁻¹ of less than 70 Pascal-seconds, measured in accordance with ISO 11443. Viscosity can also be evaluated using parallel plate rheometry according to ASTM D4440: 2001.

The thermoplastic compositions can have a heat deflection temperature (HDT) of greater than 90° C., was measured at 1.8 MPa on 6.4 mm thick bars according to ISO 75.

Electrical resistivity, including surface resistivity and volume resistivity can be determined on disc-shaped samples with having a diameter of about 85 mm and a thickness of about 3 mm in accordance with EC60093/ASTM D150. Dielectric constant and electrical dissipation factor can be determined using molded discs having a diameter of about 85 mm diameter and a thickness of about 3 mm, in accordance with EC60093/ASTM D150-81 (2001).

Comparative tracking index (CTI) can be determined using molded discs having a diameter of about 85 mm diameter and a thickness of about 3 mm conditioned at 23° C. and 50 percent relative humidity, and measured at 23° C. and 54 percent relative humidity according to ASTM D3638, IEC 60112: 1979.

Chemical resistance can be evaluated on ASTM tensile bars (13 mm (w)×57 mm (1)×3.2 mm (t)) at 23° C. or 80° C., after exposure to the chemical for 7 days according to ASTM D543-95 (2001) under a strain of 0.5%, 1%, or 1.5%.

Scratch resistance can be evaluated using a varying load up to 120 millineutons, 500 micrometer scratch length, 10 micrometers per second scratch velocity, and a 48 millineuton profile. Scratch width and height are determined using photomicrography. Scratch height is the distance between pile-up peak and the bottom of the groove. Scratch width is the distance between the peaks of the pile-up on each side of the groove. Residual scratch depth is the height between the nominal surface and the bottom of the groove. Scratch pile-up height is the height of the peak of the pile-up above the nominal surface. Scratch recovery is determined using the equation:

Recovery(%)=(depth1−depth2)*100/depth1

wherein depth1 and depth2 represent the scratch depths during and after the scratch at an arbitrary chosen distance of 300 micrometer in a 500 micrometer scratch length. Scratch visibility factor is the ratio of pile up height and scratch width.

Improved stability, i.e., weatherability or aging performance can be determined by monitoring polymer molecular weight. Polymer molecular weight and polydispersity can be measured by GPC in methylene chloride solvent using polystyrene calibration standards to determine and report relative molecular weights (values reported are polycarbonate molecular weight relative to polystyrene, not absolute polycarbonate molecular weight numbers). Changes in weight average molecular weight can be used. This provides a means of measuring changes in chain length of a polymeric material, which can be used to determine the extent of degradation of the thermoplastic as a result of exposure or processing. Degraded materials generally show reduced molecular weight, and exhibit reduced physical properties. Molecular weights can be determined before and after processing, and the molecular weight retention is the molecular weight after processing as a percentage of the molecular weight before processing.

The polycarbonate in the thermoplastic compositions described herein retains 80 to 98 percent, specifically 85 to 98 percent, more specifically 90 to 98 percent of its initial weight average molecular weight after processing, i.e., after extrusion.

Heat aging performance can be evaluated on ASTM tensile bars (3.3 mm (w)×15 mm (1)×3.2 mm (t) at 90° C., 110° C., 130° C., and 150° C. for up to 500 hours. Aging performance can then be evaluated in part by measurement of the retention of elongation at break. Elongation at break is determined in accordance with ISO 527-5: 1997.

The percent retention of elongation at break of a 3 mm×15 mm 3.2 mm bar molded from the composition, and measured in accordance with ISO 527-5: 1997, is greater than 40 percent, specifically greater than 60%, and even more specifically greater than 80% than after heat aging at 130° C. for 500 hours.

Shaped, formed, or molded articles comprising the thermoplastic compositions are also provided. The thermoplastic compositions can be molded into useful shaped articles by a variety of means such as injection molding, extrusion, rotational molding, blow molding, and thermoforming to form a variety of different articles.

Specific exemplary articles include computer and business machine housings such as housings for monitors, handheld electronic device housings such as housings for cell phones, electrical connectors, and components of lighting fixtures, ornaments, home appliances, roofs, greenhouses, sun rooms, swimming pool enclosures, electronic device casings and signs, and the like. In addition, the thermoplastic compositions can be used for such applications as automotive parts, including panel and trim, spoilers, luggage doors, body panels, as well as walls and structural parts in recreation vehicles. The thermoplastic compositions are particularly useful for load-bearing components, particularly load-bearing automotive components.

The thermoplastic compositions are further illustrated by the following non-limiting examples.

### EXAMPLES

In the following Examples, “E” designates an example in accordance with the disclosed embodiments, and “C” designates a comparative example. All amounts are in weight percent, unless specified otherwise.

The thermoplastic compositions described in the following examples were prepared from the components described in Table 1.

TABLE 1

| Component | Description | Supplier |
|---|---|---|
| PC-1 | BPA polycarbonate resin made by an interfacial process | SABIC |
| | with an MVR at 300° C./1.2 kg of 23.5-28.5 g/10 min. | Innovative |
| | | Plastics |
| PC-2 | BPA polycarbonate resin made by the interfacial process | SABIC |
| | with an MVR at 300° C./1.2 kg, of 5.1-6.9 g/10 min | Innovative |
| | | Plastics |
| SAN | Styrene-acrylonitrile copolymer comprising 15-35 wt. % | SABIC |
| | acrylonitrile with an melt flow of 18-24 cm³/10 min at | Innovative |
| | 220° C./1.2 kg (trade name SAN 581) | Plastics |
| HRG | High rubber graft emulsion polymerized ABS comprising | SABIC |
| | of 9.6-12.6 wt % acrylonitrile and 37-40 wt % of styrene | Innovative |
| | grafted to 49-51 wt % of polybutadiene with cross-link | Plastics |
| | density of 43-55% | |
| EVA | Poly(ethylene-vinyl acetate) copolymer with about 50 wt % | Lanxess |
| | of vinyl acetate (trade name LEVAPRENE 500 ™) | |
| SMA | Poly(styrene maleic-anhydride) (trade name DYLARK- | Nova |
| | 250-80 ™) | Chemicals |
| PMMA | Poly(methyl methacrylate) (trade name F7900) | Cyrus Indus. |
| PETS | Pentaerythritol tetrastearate | Ciba |
| Antioxidant | Antioxidant (trade name IRGANOX ™ 1010) | Ciba |

In each of the examples, samples were prepared by melt extrusion on a Werner & Pfleiderer™ 25 mm twin screw extruder at a nominal melt temperature of about 260° C., about 0.7 bars of vacuum, and about 300 rpm. The extrudate was pelletized and dried at about 100° C. for about 2 hours. To make test specimens, the dried pellets were injection molded on an 110-ton injection molding machine at a nominal melt temperature of 260° C., with the melt temperature approximately 5 to 10° C. higher.

Properties of the thermoplastic compositions were determined as described above.

### Examples C1-C4

In order to determine the optimal vinyl acetate and ethylene content in the EVA, four samples were prepared using 65 wt. % of PC, 17 wt. % of SAN, and 16 wt. % of a poly(ethylene vinyl acetate) copolymer containing varying levels of vinyl acetate as shown in Table 2.

TABLE 2

| | Units | C1 | C2 | C3 | C4 |
|---|---|---|---|---|---|
| Vinyl acetate content | % | 40 | 45 | 50 | 80 |
| Property | | | | | |
| Observations | | A1; B1 | A1; B1; | A1; B1; | A2; B2; C2 |
| | | C1 | C1 | | |
| Young's modulus | MPa | 2052 | 2116 | 2194 | 2298 |
| Tensile strength | MPa | 44.3 | 49.5 | 50.9 | 53.6 |
| Elongation at break | % | 17 | 27 | 98 | 92 |

A1: Die swelling in extrudates
A2: High die swelling in extrudates
B1: Delamination after tensile strength testing; visual observation
B2: Extensive delamination after tensile strength test
C1: Faint smell of acetic acid
C2: Acute smell of acetic acid

The data in Table 2 show that higher vinyl acetate content leads to higher deacetylation and delamination. The best combination of mechanical properties is observed with 50 wt. % of vinyl acetate in the copolymer.

### Examples C5-C9

These examples show the effect of varying the relative amounts of HRG and EVA copolymer in the impact modifier component. Formulations and properties are shown in Table 3.

TABLE 3

| | Unit | C5 | C6 | C7 | C8 | C9 |
|---|---|---|---|---|---|---|
| Component | | | | | | |
| PC-1 | Wt. % | 46.5 | 46.5 | 46.5 | 46.5 | 46.5 |
| PC-2 | Wt. % | 19.9 | 19.9 | 19.9 | 19.9 | 19.9 |
| SAN | Wt. % | 17.0 | 17.0 | 17.0 | 17.0 | 17.0 |
| EVA | Wt. % | 0 | 8.0 | 10.0 | 12.0 | 16.0 |
| HRG | Wt % | 16.0 | 8.0 | 6.0 | 4.0 | 0 |
| PETS | Wt. % | 0.1 | 0.1 | 0.1 | 0.1 | 0.1 |
| Antioxidant | Wt. % | 0.5 | 0.5 | 0.5 | 0.5 | 0.5 |
| Property | | | | | | |
| Young's Modulus | Gpa | 2.4 | 2.2 | 2.2 | 2.1 | 2.0 |
| Tensile strength | MPa | 54.4 | 50.6 | 49.1 | 48.4 | 44.3 |
| Elongation at break | % | 74 | 28 | 24 | 17 | 17 |
| Flow (MVR) | cm³/10 min | 13.8 | 24.5 | 28 | 33 | — |
| Heat Deflection | ° C. | 102 | 99 | 100 | 100 | 98 |
| Delamination after | | No | No | No | Slight | Yes |
| tensile strength test* | | | | | | |

*Visual observation

The data in Table 3 show that with increasing EVA, flow improves, but mechanical properties such as modulus, tensile strength, and percent elongation at break degrade. HDT degrades marginally, and delamination after the tensile strength test increases. Other tests show that yellowness increases with increasing HRG content, and aging performance deteriorates (data not shown). These examples demonstrate the difficulty in achieving a good balance of flow properties, mechanical properties, and aging properties.

### Examples E1-E4 and C10-C16

The following examples show the effect of using two different compatibilizers, poly(styrene maleic anhydride) (SMA) and poly(methyl methacrylate) (PMMA) in polycarbonate compositions containing EVA as an impact modifier and SAN as a flow modifier. Formulations and properties are shown in Table 4.

The data in Table 4 show that the best impact strength in compositions containing PMMA as a compatibilizer are at high ratios of EVA:PMMA (e.g., C11 and 12). However, these samples also delaminate after tensile strength testing. Although impact strength decreases with lower EVA:PMMA ratios (e.g., C13-C15), a 1:1 ratio of EVA:PMMA (C15) provides compositions having a combination of the highest modulus and tensile strength with no delamination.

Advantageously, use of SMA as a compatibilizer shows only slight or no delamination at all ratios of EVA:SMA tested. In addition, impact strength is not significantly adversely affected by use of lower ratios of EVA:SMA. The best balance of mechanical properties is obtained using an EVA:SMA ratio of 10:6 (Example E7).

### Examples E5 and C14

Further testing of a composition containing a polycarbonate, EVA impact modifier, SAN flow modifier, and SMA compatibilizer, and a comparative composition containing a polycarbonate, HRG impact modifier, and SAN flow modifier were conducted. The compositions and their properties are shown in Table 5.

TABLE 4

| | Unit | C10 | C11 | C12 | C13 | C14 | C15 | E1 | E2 | E3 | E4 |
|---|---|---|---|---|---|---|---|---|---|---|---|
| Component | | | | | | | | | | | |
| PC-1 | Wt. % | 46.5 | 46.5 | 46.5 | 46.5 | 46.5 | 46.5 | 46.5 | 46.5 | 46.5 | 46.5 |
| PC-2 | Wt. % | 19.9 | 19.9 | 19.9 | 19.9 | 19.9 | 19.9 | 19.9 | 19.9 | 19.9 | 19.9 |
| SAN | Wt. % | 17.0 | 17.0 | 17.0 | 17.0 | 17.0 | 17.0 | 17.0 | 17.0 | 17.0 | 17.0 |
| EVA | Wt. % | 16.0 | 15.0 | 14.0 | 12.0 | 10.0 | 8.0 | 15.0 | 14.0 | 12.0 | 10.0 |
| PMMA | Wt % | 0 | 1.0 | 2.0 | 4.0 | 6.0 | 8.0 | — | — | — | — |
| SMA | Wt % | 0 | — | — | — | — | — | 1.0 | 2.0 | 4.0 | 6.0 |
| PETS | Wt. % | 0.1 | 0.1 | 0.1 | 0.1 | 0.1 | 0.1 | 0.1 | 0.1 | 0.1 | 0.1 |
| Antioxidant | Wt. % | 0.5 | 0.5 | 0.5 | 0.5 | 0.5 | 0.5 | 0.5 | 0.5 | 0.5 | 0.5 |
| Property | | | | | | | | | | | |
| Young's Modulus | GPa | 2.2 | 2.2 | 2.2 | 2.3 | 2.3 | 2.5 | 2.2 | 2.2 | 2.4 | 2.5 |
| Tensile strength | MPa | 51 | 51.9 | 52.8 | 55.6 | 56.1 | 60.2 | 51.1 | 52.8 | 54.5 | 57.5 |
| Elongation at break | % | 98 | 94 | 92 | 103 | 97 | 98 | 90 | 92 | 86 | 89 |
| Notched Izod impact | kJ/m² | 60 | 50.9 | 50.9 | 42.2 | 41.7 | 40.4 | 47.1 | 51. | 48.1 | 50.2 |
| at 23° C. | | | | | | | | | | | |
| Delamination after | | Yes | Yes | Yes | Yes | Slight | No | Slight/ | No | No | No |
| tensile strength test* | | | | | | | | No | | | |

*Visual observation

TABLE 5

| | Unit | C16 | E5 |
|---|---|---|---|
| Component | | | |
| PC-1 | Wt. % | 34.9 | 45.5 |
| PC-2 | Wt. % | 18.8 | 19.5 |
| SAN | Wt. % | 27.8 | 16.1 |
| HRG | Wt % | 17.9 | — |
| EVA | Wt. % | 0 | 11.2 |
| SMA | Wt. % | 0 | 7.3 |
| PETS | Wt. % | 0.4 | 0.3 |
| Antioxidant | Wt. % | 0.3 | 0.3 |
| Property | | | |
| Young's Modulus | GPa | 2.5 | 2.3 |
| Yield Stress | MPa | 54.9 | 54.9 |
| Yield Strain | % | 4.1 | 5.2 |
| Stress at Break | MPa | 44.7 | 39.8 |
| Strain at Break | % | 79.9 | 83.7 |
| Flow (MVR), | cm³/10 min | 20 | 30 |
| 5.0 Kg, 260° C. | | | |
| Heat Deflection Temp | ° C. | 103 | 102 |
| Notched Izod | kJ/m² | 35 | 51 |
| Impact at 23° C. | | | |
| MAI at 23° C. | J | 116 (ductile) | 89 (ductile) |
| MAI at 0° C. | J | 106 (ductile) | 32 (ductile/brittle) |
| MAI at −10° C. | J | 90 (ductile) | 15 (brittle) |
| Scratch width | microns | 32.9 | 41.3 |
| Scratch height | nm | 2100 | 1725 |
| Residual scratch Depth | nm | 1498 | 1664 |
| Scratch pile-up Height | μm | 602 | 261 |
| Scratch recovery | % | 63.3 | 74.4 |
| Scratch visibility | | 18.31 × 10⁻³ | 6.05 × 10⁻³ |
| Factor | | | |
| Surface resistivity | ohm | 4.02 × 10¹⁷ | 2.79 × 10¹⁷ |
| Volume resistivity | ohm/cm | 2.38 × 10¹⁷ | 1.82 × 10¹⁷ |
| Dielectric constant | | 2.82 | 2.80 |
| at 1 MHz | | | |
| Dissipation Factor | | 7.63 × 10⁻³ | 22.5 × 10⁻³ |
| at 1 MHz | | | |
| CTI | V | 250 to 399 | 600 and above |

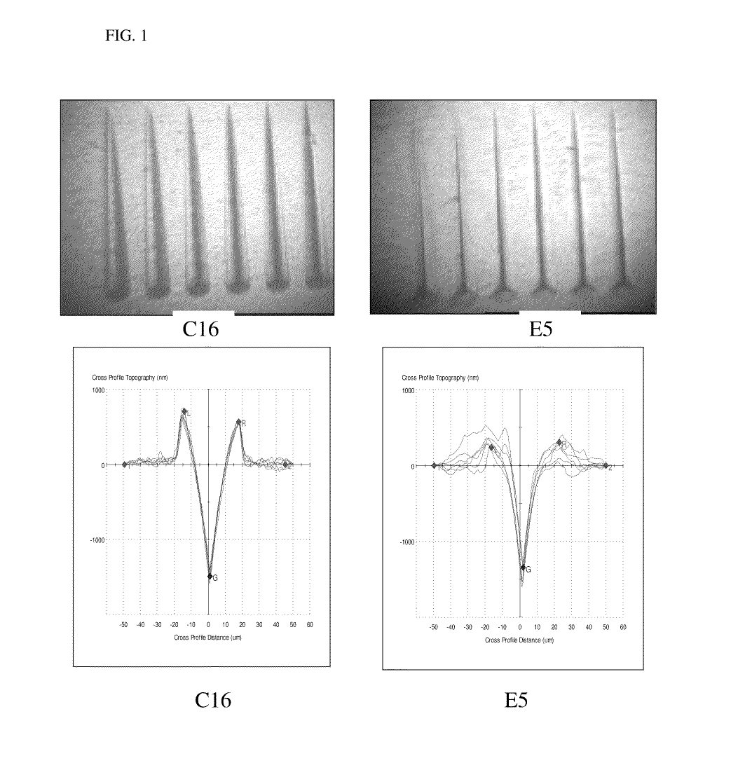

The scratch resistance of Examples C16 and E5 are further illustrated by the results presented in FIGS. 1 to 4. The width of the scratches in the photomicrographs in FIG. 1 illustrate the superior ability of the thermoplastic composition of E5 to resist scratching compared to C16. The diagram of cross profile topography in FIG. 1 further illustrates the scratch resistance of the thermoplastic composition in E5.

TABLE 6

| | C16 | | | | | | E5 | | | | | |
|---|---|---|---|---|---|---|---|---|---|---|---|---|
| | Retention in yield | | | Retention in | | | Retention in | | | Retention | | |
| | strength/break | | | nominal | | | yield strength/ | | | in nominal | | |
| | strength | | | strain at break | | | break strength | | | strain at break | | |
| Strain | 0.5% | 1.0% | 1.5% | 0.5% | 1.0% | 1.5% | 0.5% | 1.0% | 1.5% | 0.5% | 1.0% | 1.5% |
| Chemical | | | | | | | | | | | | |
| Isopropyl alcohol (90%) | 99% | 99% | 66% | 84% | 121% | 17% | 99% | 99% | 100% | 92% | 97% | 98% |
| Engine oil 5W-50 | 101% | 100% | 98% | 82% | 101% | 120% | 101% | 101% | 101% | 84% | 105% | 98% |
| Ethylene glycol | 100% | 100% | 98% | 106% | 134% | 127% | 101% | 101% | 101% | 88% | 103% | 100% |
| RUST-A-REST ™ | 105% | 100% | 98% | 84% | 96% | 114% | 100% | 101% | 100% | 100% | 111% | 100% |
| Tanning lotion | 101% | 20% | 0% | 84% | 19% | 0% | 100% | 100% | 100% | 93% | 106% | 99% |
| Ethanol-70% | 100% | 99% | 99% | 96% | 121% | 129% | 99% | 99% | 100% | 91% | 112% | 102% |
| WINDEX ® Blue | — | 71% | — | — | 47% | — | — | 98% | — | — | 85% | — |
| COPPERTONE ® | — | 0% | — | — | 0% | — | — | 98% | — | — | 39% | — |

RUST-A-REST ™ is commercially available from PPG
“Tanning Lotion” is commercially available from Lancaster
COPPERTONE ® Suntan lotion is commercially available from Schering-Plough Healthcare Products Inc.
WINDEX ® Blue glass cleaner is commercially available from S.C. Johnson

Examples C16 and E5 were further tested for chemical resistance at 0.5% strain, 1% strain, and 5% strain. The results are shown in Table 6.

The data in Table 6 demonstrate that E5 has significantly improved chemical resistance compared to C16 at 1.5% and 1.0% strain levels using 90% isopropyl alcohol, WINDEX® Blue and two different types of tanning lotion, and comparable chemical resistance for other types of chemicals.

Chemical resistance at 80° C. using a strain of 1% is shown in Table 7.

TABLE 7

| | C16 | | E5 | |
|---|---|---|---|---|
| | Retention in | | Retention in | |
| | yield | Retention | yield | Retention |
| | strength/ | in nominal | strength/ | in nominal |
| | break | strain | break | strain |
| Chemical | strength | at break | strength | at break |
| Grease Lithium | 101% | 127% | 100% | 86% |
| Diesel | 70% | 25% | 100% | 96% |
| Engine oil 5W-50 | 100% | 98% | 100% | 114% |
| Ethylene Glycol | 100% | 96% | 100% | 98% |
| RUST-A-REST ™ | 100% | 118% | 100% | 138% |
| ARMOUR ALL | 0% | 0% | 100% | 72% |
| PROTECTANT ® | | | | |

The results in Table 7 show that E5 has significantly improved chemical resistance to ARMOUR ALL PROTECTANT® and Diesel and comparative chemical resistance to other chemicals.

Heat aging performance for Examples C16 and E5 is shown in Table 8. In Table 8, Mₙ refers to number average molecular weight, M_{w} refers to weight average molecular weight, and PDI refers to polydispersity index.

TABLE 8

| Examples | Aging Conditions | Mₙ | M_{w} | PDI |
|---|---|---|---|---|
| C16 | None | 22017 | 46935 | 2.132 |
| | 110° C., 500 hours | 21247 | 47495 | 2.235 |
| E5 | None | 23399 | 51451 | 2.199 |
| | 110° C., 500 hours | 22576 | 49194 | 2.179 |

As can be seen from the data in Table 8, heat aging performance of Examples C16 and E5 are comparable with respect to Mn, Mw, and PDI of the polycarbonate.

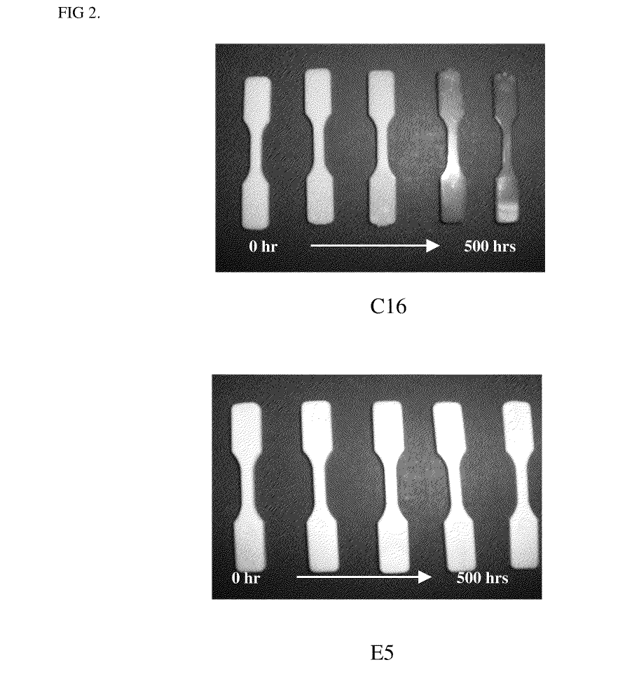

However, the visual appearance of bars molded from E5 is improved relative to C16. As shown in FIGS. 1-2, when bars were aged at 130° C. for 500 hours, bars molded from the thermoplastic composition of Example E5 did not show any visible signs of aging, while bars molded from the thermoplastic composition of C16 colored over the course of the test, an indication of degradation.

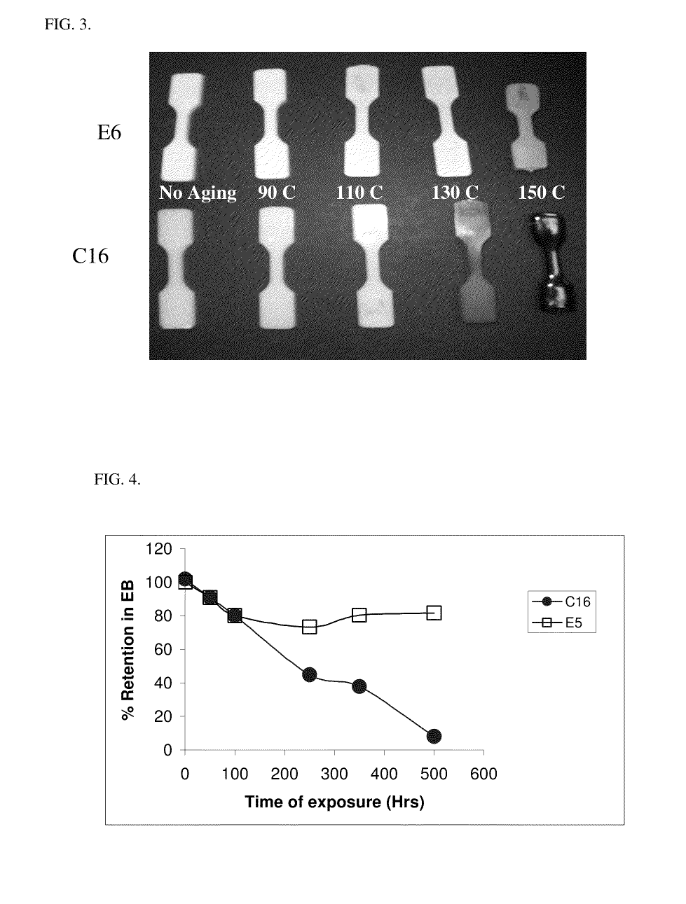

As shown in FIG. 3, when bars were aged for 500 hours at successively higher temperatures, up to 150° C., bars of the thermoplastic composition in E1 exhibited less color change, thus less degradation, than those of C1.

The data in the plot presented in FIG. 4 illustrates that the thermoplastic composition of E5 provided better percent retention in elongation at break, thus less degradation in mechanical properties, than that of C16, when bars of the thermoplastic compositions were aged at 130° C. for 500 hours.

As can be seen from the data in Tables 2 to 8, thermoplastic compositions having an EVA impact modifier and an SMA compatibilizer results in improved properties, in particular, improved scratch resistance, chemical resistance to at least some solvents, heat aging, and Comparative Tracking Index, without significantly reducing other properties, such as heat deflection temperature or tensile modulus.

The singular forms “a,” “an,” and “the” include plural referents unless the context clearly dictates otherwise. The suffix “(s)” as used herein is intended to include both the singular and the plural of the term that it modifies, thereby including at least one of that term (e.g., the colorant(s) includes at least one colorants). Unless defined otherwise, technical and scientific terms used herein have the same meaning as is commonly understood by one of skill in the art to which this invention belongs. “Optional” or “optionally” means that the subsequently described event or circumstance can or cannot occur, and that the description includes instances where the event occurs and instances where it does not. The endpoints of all ranges directed to the same component or property are inclusive of the endpoint and independently combinable. All references are incorporated herein by reference.

Compounds are described using standard nomenclature. For example, any position not substituted by any indicated group is understood to have its valency filled by a bond as indicated, or a hydrogen atom. A dash (“−”) that is not between two letters or symbols is used to indicate a point of attachment for a substituent. For example, —CHO is attached through carbon of the carbonyl group. The term “substituted” as used herein means that any at least one hydrogen on the designated atom or group is replaced with another group, provided that the designated atom's normal valence is not exceeded. When the substituent is oxo (i.e., ═O), then two hydrogens on the atom are replaced. Also as used herein, the term “combination” is inclusive of blends, mixtures, alloys, reaction products, or the like.

An “organic group” as used herein means a saturated or unsaturated (including aromatic) hydrocarbon having a total of the indicated number of carbon atoms and that can be unsubstituted or unsubstituted with one or more of halogen, nitrogen, sulfur, or oxygen, provided that such substituents do not significantly adversely affect the desired properties of the thermoplastic composition, for example transparency, heat resistance, or the like. Exemplary substituents include alkyl, alkenyl, akynyl, cycloalkyl, aryl, alkylaryl, arylalkyl, —NO₂, SH, —CN, OH, halogen, alkoxy, aryloxy, acyl, alkoxy carbonyl, and amide groups.

As used herein, the term “hydrocarbyl” refers broadly to a substituent comprising carbon and hydrogen, optionally with at least one heteroatom, for example, oxygen, nitrogen, halogen, or sulfur; “alkyl” refers to a straight or branched chain monovalent hydrocarbon group; “alkylene” refers to a straight or branched chain divalent hydrocarbon group; “alkylidene” refers to a straight or branched chain divalent hydrocarbon group, with both valences on a single common carbon atom; “alkenyl” refers to a straight or branched chain monovalent hydrocarbon group having at least two carbons joined by a carbon-carbon double bond; “cycloalkyl” refers to a non-aromatic monovalent monocyclic or multicylic hydrocarbon group having at least three carbon atoms, “cycloalkenyl” refers to a non-aromatic cyclic divalent hydrocarbon group having at least three carbon atoms, with at least one degree of unsaturation; “aryl” refers to an aromatic monovalent group containing only carbon in the aromatic ring or rings; “arylene” refers to an aromatic divalent group containing only carbon in the aromatic ring or rings; “alkylaryl” refers to an aryl group that has been substituted with an alkyl group as defined above, with 4-methylphenyl being an exemplary alkylaryl group; “arylalkyl” refers to an alkyl group that has been substituted with an aryl group as defined above, with benzyl being an exemplary arylalkyl group; “acyl” refers to an alkyl group as defined above with the indicated number of carbon atoms attached through a carbonyl carbon bridge (—C(═O)—); “alkoxy” refers to an alkyl group as defined above with the indicated number of carbon atoms attached through an oxygen bridge (—O—); and “aryloxy” refers to an aryl group as defined above with the indicated number of carbon atoms attached through an oxygen bridge (—O—).

All cited patents, patent applications, and other references are incorporated herein by reference in their entirety.

While the disclosed embodiments have been described with reference to an exemplary embodiment, it will be understood by those skilled in the art that various changes can be made and equivalents can be substituted for elements thereof without departing from the scope of that disclosed. In addition, many modifications can be made to adapt a particular situation or material to the disclosure without departing from the essential scope thereof. Therefore, it is intended that the disclosure not be limited to the particular embodiment disclosed as the best mode contemplated, but that the disclosed embodiments will include all embodiments falling within the scope of the appended claims.

1. A composition comprising:
a polymer component comprising, based on the total weight of the polymer component,
25 to 93 weight percent of a polycarbonate;
1 to 25 weight percent of a poly(vinyl acetate);
5 to 35 weight percent of a poly(monovinyl aryl-co-(meth)acrylonitrile) flow modifier; and
1 to 7.3 weight percent of a poly(monovinyl aryl-co-maleic anhydride) compatibilizer; and
an optional filler component, in an amount of 0 to 150 parts by weight of the polymer component.

2. The composition of claim 1, wherein the polycarbonate comprises units derived from bisphenol A.

3. (canceled)

4. (canceled)

5. The composition of claim 1, wherein the poly(vinyl acetate) further comprises units derived from a C₂₋₆ aliphatic terminal monoolefin.

6. The composition of claim 1, wherein the poly(vinyl acetate) is poly(ethylene vinyl acetate).

7. The composition of claim 1, wherein the flow modifier is a styrene-acrylonitrile copolymer.

8. The composition of claim 1, wherein the poly(monovinyl aryl-co- maleic) compatibilizer is a copolymer comprising units derived by polymerization of a monovinyl aryl monomer of formula: 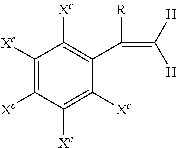
wherein each X^{c} is independently hydrogen, C₁₋₁₂ alkyl, C₃₋₁₂ cycloalkyl, C₆₋₁₂ aryl, C₇₋₁₂ aralkyl, C₇₋₁₂ alkylaryl, C₁₋₁₂ alkoxy, C₃₋₁₂ cycloalkoxy, C₆₋₁₂ aryloxy, chloro, bromo, or hydroxy, and R is hydrogen, C₁₋₅ alkyl, bromo, or chloro; and a maleic derivative of formula: 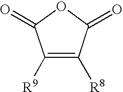
wherein R⁸ and R⁹ are each independently hydrogen, C₁₋₁₂ alkyl, C₃₋₁₂ cycloalkyl, C₆₋₁₂ aryl, C₇₋₁₂ aralkyl, C₇₋₁₂ alkylaryl, or a halogen.

9. The composition of claim 8, wherein R⁸ and R⁹ are each hydrogen.

10. The composition of claim 1, wherein the compatibilizer is poly(styrene-co-maleic anhydride).

11. The composition of claim 1, comprising a 10 to 100 parts by weight of the filler component, based on 100 parts by weight of the polymer component filler.

12. The composition of claim 11, wherein the filler comprises talc, mica, clay, or a combination comprising at least one of the foregoing fillers.

13. The composition of claim 1, wherein the polymer component further comprising an additive, wherein the additive is an antioxidant, heat stabilizer, light stabilizer, ultraviolet light absorber, plasticizer, mold release agent, lubricant, antistatic agent, flame retardant, anti-drip agent, or gamma stabilizer, or a combination comprising at least one of the foregoing additives.

14. The composition of claim 1, wherein the percent retention of elongation at break of a 3.3 mm×15 mm 3.2 mm bar molded from the composition, and measured in accordance with ISO 527-5: 1997, is greater than 50% after heat aging at 130° C. for 500 hours.

15. The composition of claim 1, wherein the melt volume flow rate is greater than 20 cubic centimeters per ten minutes, when measured at 260° C. at 5 kilograms load, in accordance with ISO 1133.

16. The composition of claim 1, wherein a 3.2 mm thick bar comprising the composition has a notched Izod impact strength greater than or equal to 40 kilojoules per square meter when measured at 23° C. in accordance with ISO 180: 2000.

17. A composition consisting essentially of:
a polymer component comprising, based on the total weight of the polymer component,
43 to 83 weight percent of a polycarbonate comprising units derived from bisphenol A;
from 5 to 20 weight percent of a poly(ethylene vinyl acetate);
from 10 to 25 weight percent of a poly(styrene-co-acrylonitrile) flow modifier; and
from 2 to 7.3 weight percent of a poly(styrene-co-maleic anhydride) compatibilizer; and
an optional filler component, in an amount of 0 to 150 parts by weight of the polymer component.

18. A method of forming the composition of claim 1, comprising combining the components of the composition of claim 1.

19. An article comprising the composition of claim 1.

20. A method for the manufacture of an article, comprising molding, casting, or shaping the composition of claim 1.
